(19) United States
(12) Patent Application Publication
(10) Pub. No.: US 2015/0020629 A1
(43) Pub. Date: Jan. 22, 2015

(54) Gear Noise Reduction in Opposed-Piston Engines

(71) Applicant: Achates Power, Inc., San Diego, CA (US)

(72) Inventors: John J. Koszewnik, San Diego, CA (US); Balazs V. Palfai, Carlsbad, CA (US)

(73) Assignee: Achates Power, Inc., San Diego, CA (US)

(21) Appl. No.: 14/074,618

(22) Filed: Nov. 7, 2013

Related U.S. Application Data
(63) Continuation-in-part of application No. 13/944,787, filed on Jul. 17, 2013.

(51) Int. Cl. F16H 55/08

(52) U.S. Cl. CPC F16H 55/08
USPC 74/445

(57) ABSTRACT

A quiet-running, multi-layer gear assembly includes a stiff center member sandwiched between a pair of outer members. At least one of the outer members is compliant; preferably, both are. The stiff center member has an outer peripheral surface with gear teeth. Each of the outer members has an outer peripheral surface with gear teeth disposed in a respective directed axial thrust pattern. The center and outer members are joined on a central hub with their outer peripheral surfaces aligned so as to form a gear assembly.

### PRIORITY

This patent application is a continuation-in-part of U.S. patent application Ser. No. 13/944,787, filed Jul. 17, 2013.

### RELATED APPLICATIONS

This application contains subject matter related to that of U.S. patent application Ser. No. 13/385,539, filed Feb. 23, 2012.

### BACKGROUND

The field is reduction of noise, vibration, and harshness (NVH) in an internal combustion engine. More specifically, the field covers reduction of gear noise and vibration in an opposed-piston engine.

Gear vibration and clash in an internal combustion engine lead to intense whining and/or sharp impulse noise which can cause extreme operator and passenger discomfort. Engine whine and rattle also add to the constant cacophony that makes proximity to transportation routes very unpleasant. Consequently, performance standards and environmental regulations relating to vehicles increasingly include NVH limits.

Whenever gears interface with each other, there is side contact between the respective gear teeth. These teeth side contacts are classified as overrunning side contacts or driving side contacts. Because of these contacts, there is usually a gap between the interfacing gear teeth. As the gears rotate, these gaps are closed when the teeth make new contacts, which can result in gear rattle. Backlash in the gear trains of opposed-piston engines during torque reversals will also produce gear rattle.

The gear train of an opposed-piston engine with dual crankshafts inherently experiences torque reversal events that produce clatter and vibration. In the case where a phase difference is provided between the crankshafts in order to differentiate port opening and closing times, the gear train is subjected to a torque reversal at least once every cycle of engine operation. Even without an inter-crankshaft phase difference, momentary inter-gear torque reversals result from idler bounce and/or gear/shaft rotational distortion. Torque reversals result in crank train rattle when gear backlash and powertrain gear teeth clearances are present.

U.S. Pat. No. 3,719,103 describes a multi-ply gear construction designed to be quiet-running. The gear construction includes a plastic center panel fastened between a pair of opposite metal side plates. Peripheral teeth are cut into a peripheral edge of the assembled gear. The plastic material yields to the cutting process, but the metal material does not. As a result, the central plastic segment of each tooth expands after the cutting operation such that the surfaces of the center segment are displaced outwardly of the corresponding side metal segments. With this multi-ply construction a gear is meshed with another gear in a manner eliminating backlash and preventing metal-to metal contact.

With respect to elimination of gear noise, the multi-ply gear construction described in the '103 patent is deficient in at least two important respects. By cutting gear teeth in a single fabrication step, the post-cutting expansion of the gear segments in the plastic center panel is imprecise and uneven, leading to a substantial variance in contact surface contours which allow a certain level of gear teeth side shifts with metal-to-metal contact noise. Further, the multi-ply gear is mounted to a shaft by means of a mounting boss that acts on only one of the metal side plates, which permits rotational distortion between that plate and the other two plates of the gear.

Consequently, opposed-piston engines need quiet-running gears constructed to prevent gear teeth shifts caused by torque reversals, crankshaft phase differences, and idler bounce.

### SUMMARY

These problems are solved with a quiet-running multi-layer gear assembly wherein a stiff center member is sandwiched between a pair of outer members. In a preferred aspect, both outer members are compliant. In some aspects at least one of the outer members is compliant. The stiff center member has an outer peripheral surface with gear teeth formed thereon. Each of the compliant outer members has an outer peripheral surface with gear teeth formed thereon. In some aspects, the gear teeth on the compliant outer members are directed in a straight thrust pattern. The center and outer members are joined on a central hub with their outer peripheral surfaces aligned.

### BRIEF DESCRIPTION OF THE DRAWINGS

The below-described drawings are intended to illustrate examples discussed in the following description; they are not necessarily to scale.

FIG. 1A is a side view of a gear train in an opposed-piston engine equipped with two crankshafts. FIG. 1B is an end view of the same gear train with a gear box cover removed.

FIG. 2 shows a partially-assembled multi-ply gear assembly embodiment according to the parent application.

FIG. 3 is an exploded view showing additional elements of the multi-ply gear assembly of FIG. 2.

FIG. 4 is a three-dimensional cutaway view of the multi-ply gear assembly of FIG. 3 equipped to be mounted to a crankshaft.

FIG. 5 is a side section of a portion of the gear train of FIG. 1B at A-A.

FIG. 6 shows an embodiment of a partially assembled multi-ply gear assembly according to this specification.

FIG. 7 is an exploded view showing additional elements of the multi-ply gear assembly of FIG. 6.

FIG. 8 is a side view of a gear train in an opposed-piston engine equipped with two crankshafts wherein the multi-ply gear assembly of FIG. 6 is used.

### DETAILED DESCRIPTION

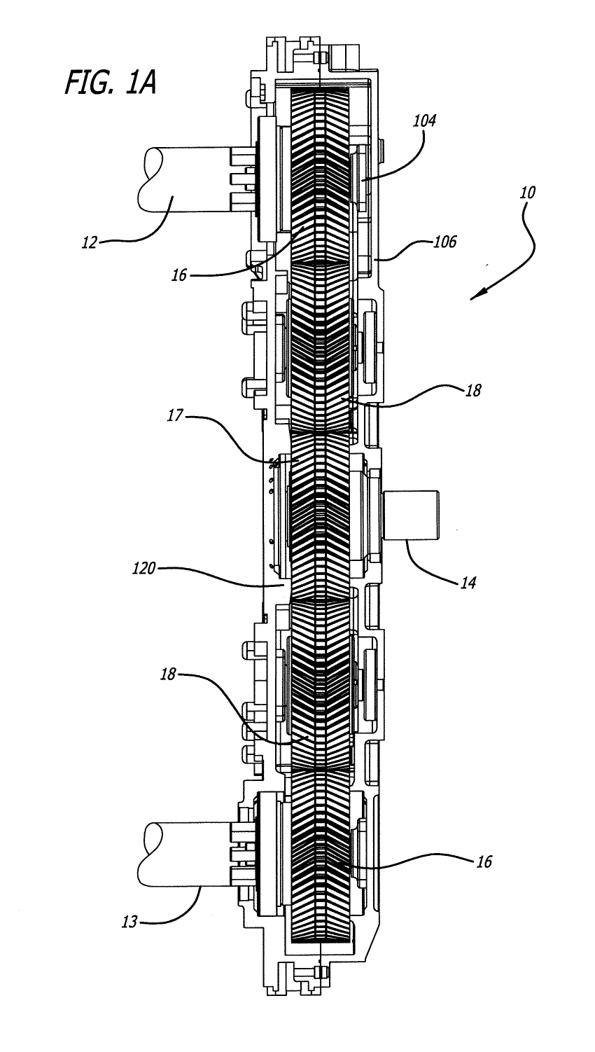

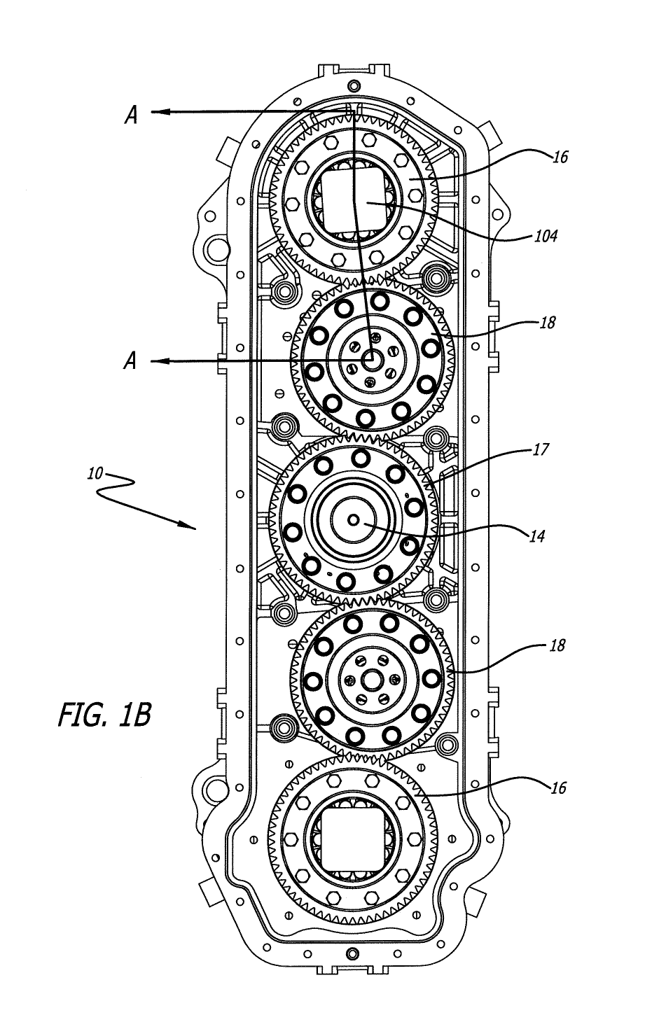

FIGS. 1A and 1B show a gear train 10 for an opposed-piston engine equipped with two crankshafts 12 and 13. The gear train 10 includes a plurality of gear assemblies (which may also be called “gears”), two of which (indicated by reference numeral 16) are fixed to respective ends of the crankshafts 12 and 13 for rotation thereby, and one of which (indicated by reference numeral 17) is fixed to the end of a power take-off shaft 19. In this configuration, two idler gear assemblies 18 are provided; as a result, the crankshafts 12 and 13 are co-rotating, that is to say, they rotate in the same direction. However, this is not meant to so limit the scope of this disclosure. In fact, the gear assembly construction disclosed in this specification can be incorporated into gear trains with fewer, or more, idlers, and with counter-rotating crankshafts.

It is desirable to provide quiet-running gears for a gear train such as the gear train 10 by use of a multi-ply gear assembly that reduces or eliminates noise and vibration caused by gear rattle.

### Quiet-Running Gear Embodiment of the Parent Application

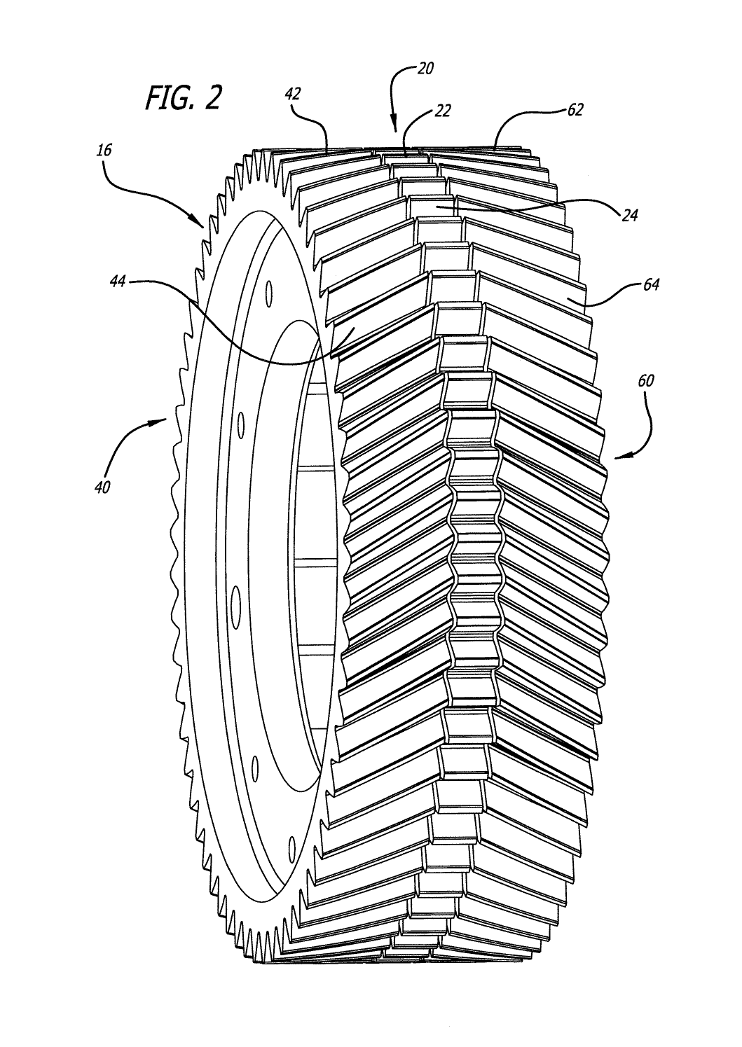

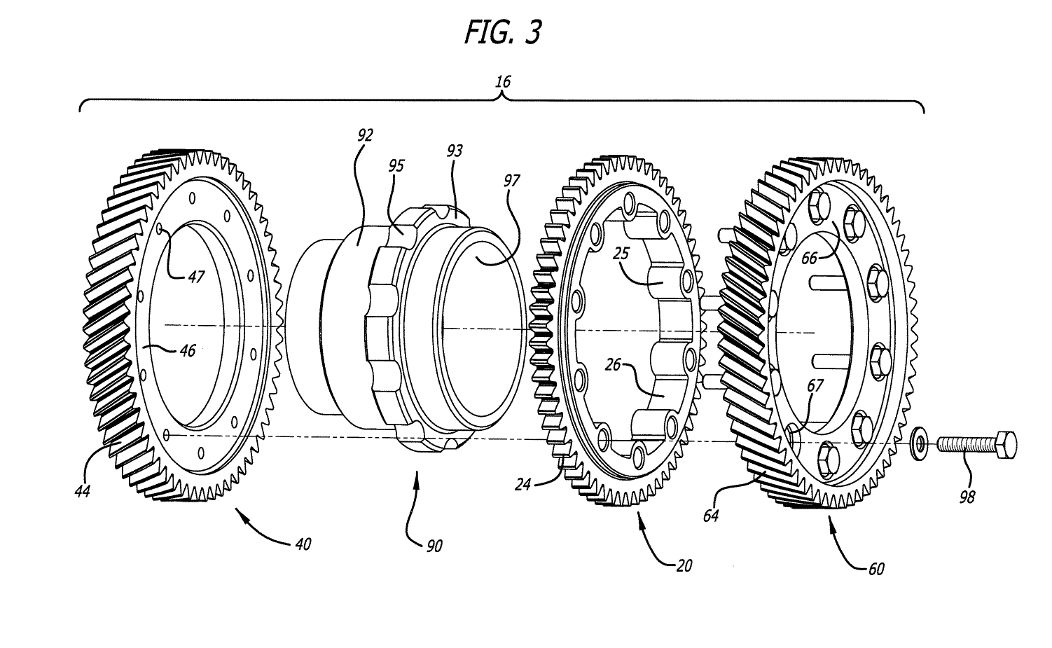

A quiet-running gear embodiment according to parent application Ser. No. 13/944,787 is shown in FIGS. 2 and 3. The gear assembly of FIGS. 2 and 3 is disclosed and illustrated with reference to a crank gear assembly 16, with the understanding that the components and the construction are found in the idler and power take-off gear assemblies 17 and 18 as well. As per FIGS. 2 and 3, a quiet-running multi-layer gear assembly 16 includes a compliant center member 20 sandwiched between a pair of stiff outer members 40 and 60; when the stiff outer members 40 and 60 are brought into close abutting contact with opposite sides of the compliant center member, the compliant center member 20 separates and axially spaces the stiff outer members 40 and 60. The compliant center member 20 and the stiff outer members 40 and 60 have generally annular constructions with approximately equal outer diameters. The annular construction of the compliant center member 20 includes an outer peripheral surface 22 on which gear teeth 24 are formed. The annular construction of the outer member 40 includes an outer peripheral surface 42 on which gear teeth 44 are formed. The annular construction of the outer member 60 includes an outer peripheral surface 62 on which gear teeth 64 are formed. On the outer peripheral surface 42 of the stiff outer member 40 the gear teeth 44 are disposed in a first directed axial thrust pattern; on the second stiff outer member 60, the gear teeth 64 are disposed in second directed axial thrust pattern. In some instances, the first and second directed axial thrust patterns together define oppositely-directed axial thrust patterns such as are provided on double helical or herringbone gears. On the embodiment of the compliant center member 20 shown in these figures, the gear teeth 24 project radially, thereby giving the compliant center member 20 the attributes of a spur or straight-cut gear; however this is not intended to be limiting as the gear teeth 24 may have other patterns.

As best seen in FIG. 3, the annular construction of the compliant center member 20 includes an inner surface portion with a plurality of circumferentially-spaced bosses 25. Each boss 25 is formed such that a portion of its sidewall protrudes in an inward radial direction of the compliant central member 20. As a result, the inner peripheral surface 26 of the compliant center member includes a planetary array of inwardly-directed semi-cylindrical projections. The annular construction of the stiff outer member 40 includes an inwardly projecting flange 46 with a plurality of circumferentially-spaced, threaded apertures 47 formed therein. The annular construction of the stiff outer member 60 includes an inwardly projecting flange 66 with a plurality of circumferentially-spaced, countersunk apertures 67 formed therein. A hub 90 has a generally cylindrical construction with an outer sidewall 92 and an outwardly-projecting flange 93 formed thereon. The peripheral surface of the flange 93 has a plurality of circumferentially-spaced, semicircular indentations 95 formed therein.

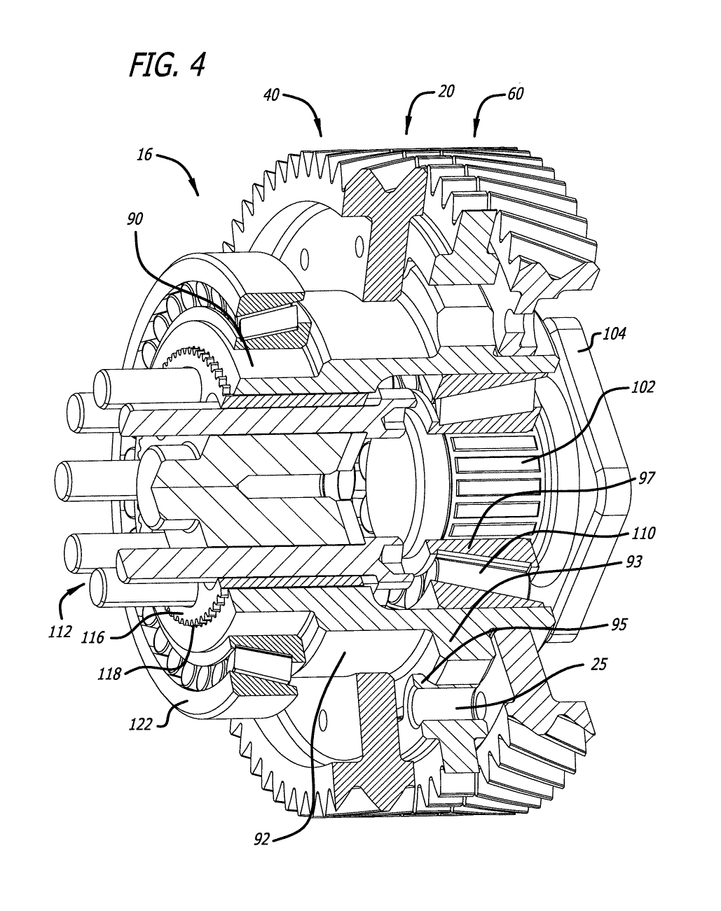

The quiet-running multi-ply gear assembly 16 is assembled as shown in FIGS. 3 and 4. The bosses 25 and the indentations 95 are aligned, and the compliant center member 20 is fitted to the flange 93, with the planetary array of inwardly-directed semi-cylindrical projections of the bosses 25 received in the plurality of indentations 95. The apertures 47 and bosses 25 are registered and the stiff outer member 40 is received on one side of the compliant center member 20. The apertures 67 and bosses 25 are registered and the stiff outer member 60 is received on the opposite side of the compliant center member 20. Threaded fasteners 98 secure the stiff outer member 60 to the stiff outer member 40, with the compliant center member 20 and the flange 93 of the hub 90 disposed therebetween. This construction ensures that, in the event of the compliant center member 20 wearing out, or otherwise failing, the torque forces will still be transferred to the hub 90.

When the members 20, 40, 60 of the multi-layer gear assembly 16 are joined on the hub 90, their outer peripheral surfaces are aligned so as to register oppositely-directed pairs of teeth 44, 64 on the stiff outer members 40 and 60 with each other and with a central tooth 24 on the compliant central member 20. Referring to FIG. 2, the patterns of the teeth 44 and 64 invest the gear assembly with low or no net axial thrust. Stated another way, the two stiff outer members 40 and 60 form a double helical or herringbone gear pattern so that axial torque acting laterally outward from the outer member 40 is counteracted by axial torque acting laterally outward from the outer member 60. Referring to FIGS. 3 and 4, in some aspects, the compliant center member 20 and the hub 90 include interdigitated elements 25 and 95 that co-operatively function as an anti-turn mechanism acting between the compliant center member 20 and the hub 90. In operation, a sudden rotational acceleration (or deceleration) of the crankshaft 12 is transmitted through the hub 90 to the compliant elements 25, which deform in response, thereby smoothing the gear's response to the impulse.

Preferably, the center member 20 is formed of a compliant or semi-compliant material such as a reinforced nylon material. For example, the compliant or semi-compliant material may be a 40% glass-filled polyamide material such as Zytel® (or possibly, another material). The outer members 40 and 60 and the hub 90 may be formed of structural steel. Although the gear assembly is secured by bolting the outer members 40 and 60 together, the members of the gear assembly 18 can be fixed together in other ways such as by keying them, or by use of splines, or by other attachment techniques.

In operation, after initial impact, (engine startup, or between braking), the compliant center member 20 will receive the torque load first and will slightly deform for a few tenths of a millimeter of compression as the stiff outer members 40 and 60 begin to absorb the gear loads. As the center member 20 deforms, the outer members 40 and 60 increasingly absorb respective torque loads, which are transmitted to the center member 20 via friction between it and the outer members 40 and 60. Consequently, it is only the center member 20 that transfers the total torque load to the hub 90 thereby reducing or eliminating gear rattle.

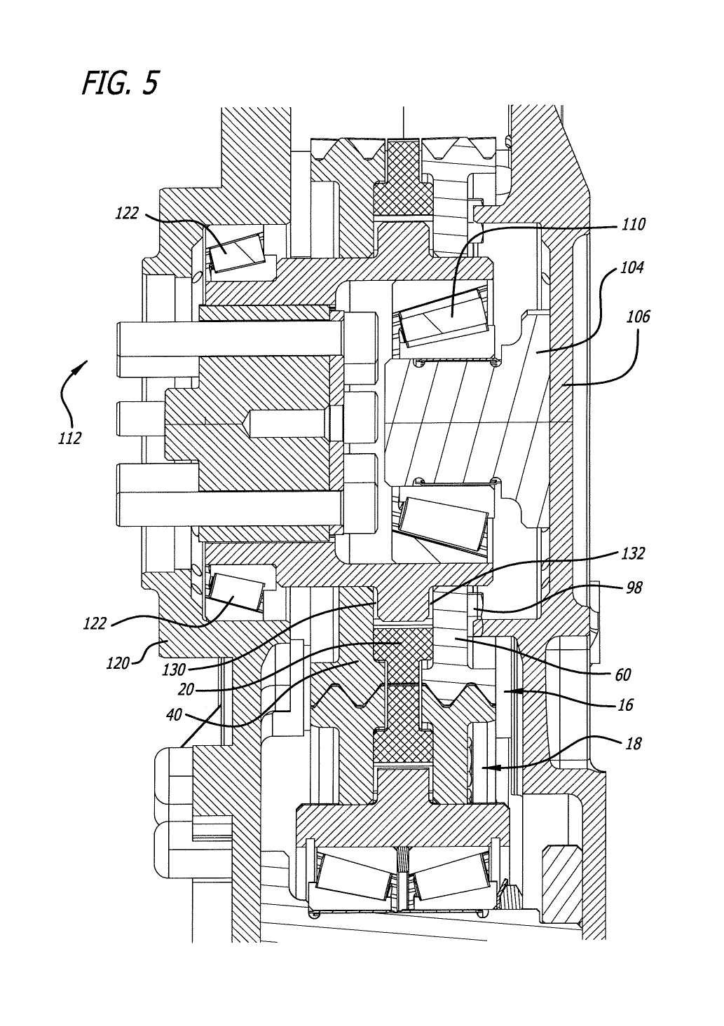

A gear train constituted of quiet-running gear assemblies can be understood with reference to FIGS. 1A, 1B, and 5, in which a gear assembly 16 of the gear train 10 functions as a crank gear. The gear assembly 16 is rotatably mounted on a post 102 mounted by a pedestal 104 to a gear box cover 106. As per FIGS. 4 and 5, the crank gear assembly 16 is rotatably coupled to the post 102 by a bearing assembly 110 acting between the post 102 and the inner sidewall 97 of the hub 90. The gear assembly 16 is mounted on an end of the crankshaft 12 by an attachment assembly 112 including exterior splines 116 that mesh with splines 118 on the inner sidewall 97 of the hub 90. As per FIGS. 4 and 5, the crank gear assembly 16 is rotatably supported on the engine casing 120 by a bearing assembly 122 acting between the engine casing 120 and the outer sidewall 92 of the hub 90. As best seen in FIGS. 1A, 1B, and 5, gear teeth 44, 24, 64 of the bearing assembly 16 are meshed with corresponding gear teeth of an abutting idler gear 18.

As best seen in FIG. 5, the construction of the gear assembly 16 provides axially floating helical gears operative to distribute a torque load between the stiff outer members 40 and 60. In this regard, the stiff outer members 40 and 60 have a floating center tolerance that creates interstitial spaces 130 and 132. These spaces allow for slight movement in the axial direction to automatically compensate for axial loads, thereby offsetting gear backlash incidents. They also allow slight relative movement to compensate for misalignments and/or tolerance variations.

As best seen in FIGS. 3, 4, and 5, the construction of the gear assembly 16 provides axial compliance operative to absorb or damp a portion of a torque load impact between the stiff outer members 40 and 60. In this regard, the threaded fasteners 98 that secure the stiff outer member 60 to the stiff outer member 40 are seated so as to preload the gear assembly 16 with a compressive bias from each stiff outer member acting on the compliant center member 20. While the compliant member 20 is compressed (axial dimension is smaller than before assembly), the threaded fasteners 98 are stretched, that is to say, they are longer than before assembly. Thus, the three members are preloaded. At an impact, the threaded fasteners 98 are stretched further and the center member 20 loses the compression somewhat. Because the threaded fasteners 98 (by further stretching them) will delay how quickly the stress in the gear train builds up they will also limit the peak. In other words, a sudden increase in torque load that tends to separate the stiff outer members 40 and 60 is damped by the axial compliance.

With reference to FIG. 1A, a method of operating the opposed-piston gear train 10 includes coupling rotating crankshaft motion from the crankshafts 12 and 13 into the gear train via gear assemblies 16 and coupling rotating motion out of the gear train via the gear assembly 17 to a power train via the power take-off shaft 19. As the crankshaft 12 rotates, a torque load is received on the members 40, 20, 60 of the gear assembly 16 that is mounted to the crankshaft. The compliant member 20 deforms in response to the torque load, which is increasingly borne by the stiff outer members 40, 60. The stiff outer members frictionally transmit the torque load to the compliant member. Finally, the torque received by the compliant member 20 is transferred to the hub of the gear 16. In some instances rotational impact between the crankshaft 12 and the gear assembly 16 is reduced by deformation of the compliant member with respect to the hub.

### Quiet-Running Gear Embodiment of the Present Application

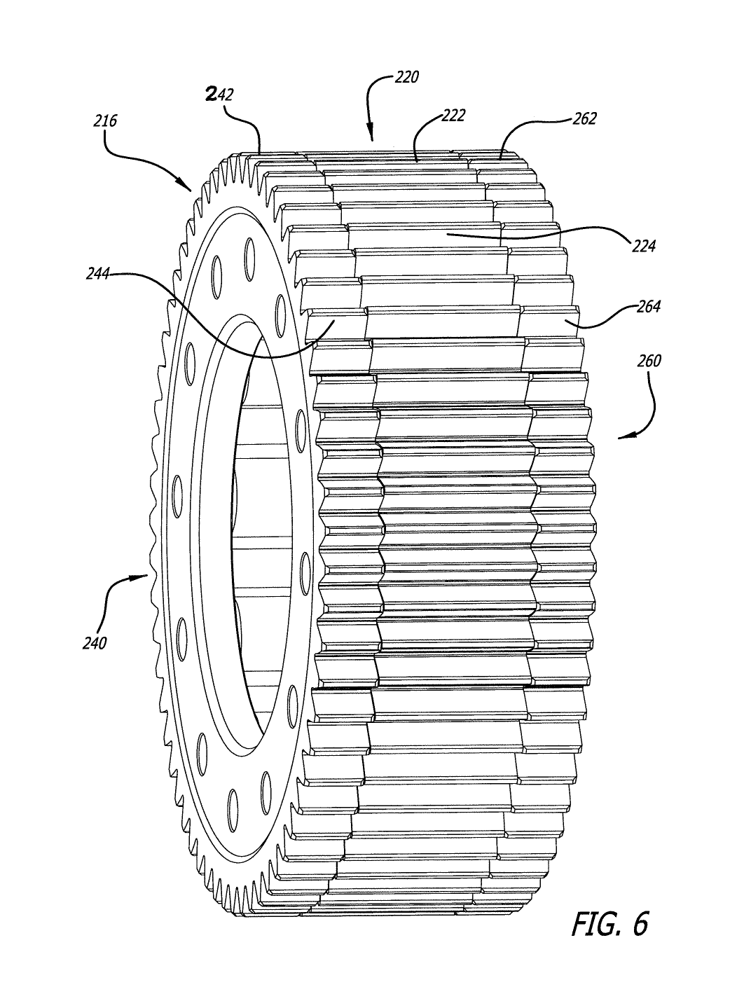

A quiet-running gear embodiment according to the present application is shown in FIGS. 6-8. In this embodiment one or more of the outer members is made of compliant material and the center member is made of a stiff material.

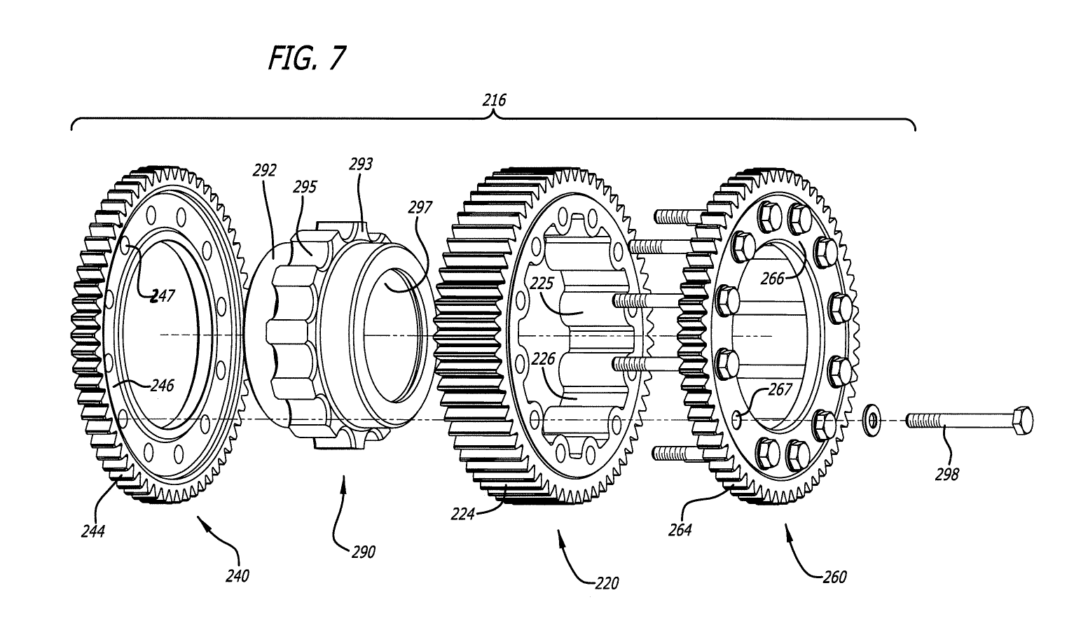

Referring now to FIGS. 6 and 7, a quiet-running multi-layer gear assembly 216 includes a stiff center member 220 sandwiched between a pair of outer members 240 and 260. At least one of the outer members 240 and 260 is compliant, which is to say that it is made or formed of a compliant material; however, in a preferred configuration both of the outer members are compliant. Accordingly, the following description refers to both of the outer members 240 and 260 as “compliant outer members”.

When the compliant outer members 240 and 260 are brought into close abutting contact with opposite sides of the stiff center member, the stiff center member 220 separates and axially spaces the compliant outer members 240 and 260. The stiff center member 220 and the compliant outer members 240 and 260 have generally annular constructions with approximately equal outer diameters. The annular construction of the center member 220 includes an outer peripheral surface 222 on which gear teeth 224 are formed. The annular construction of the outer member 240 includes an outer peripheral surface 242 on which gear teeth 244 are formed. The annular construction of the outer member 260 includes an outer peripheral surface 262 on which gear teeth 264 are formed. In this construction, the center member constitutes the performance element of the gear assembly, while the outer compliant members absorb impacts of torque reversals, crankshaft phase differences, and idler bounce. In some aspects of this gear assembly embodiment the gear teeth 244 and the gear teeth 264 are disposed in respective straight thrust patterns. Further, the gear teeth 224 project radially, thereby giving the stiff center member 220 and the compliant outer members 240 and 260 the attributes of a spur or straight-cut gear. It should be noted however, that, although all three gear members are shown with straight-cut gear patterns this is not intended to be limiting as any one or more of the gear sets may have other patterns. Thus, in some aspects, gear teeth of the outer members 240 and 260 can be disposed in respective directed axial thrust patterns as in the case of the embodiment shown in FIGS. 2 and 3.

As best seen in FIG. 7, the annular construction of the stiff center member 220 includes an inner surface portion with a plurality of circumferentially-spaced bosses 225. Each boss 225 is formed such that a portion of its sidewall protrudes in an inward radial direction of the stiff central member 220. As a result, the inner peripheral surface 226 of the compliant center member includes a planetary array of inwardly-directed semi-cylindrical projections. The annular construction of the compliant outer member 240 includes an inwardly projecting flange 246 with a plurality of circumferentially-spaced, threaded apertures 247 formed therein. The annular construction of the compliant outer member 260 includes an inwardly projecting flange 266 with a plurality of circumferentially-spaced, countersunk apertures 267 formed therein. A hub 290 has a generally cylindrical construction with an outer sidewall 292 and an outwardly-projecting flange 293 formed thereon. The peripheral surface of the flange 293 has a plurality of circumferentially-spaced, semicircular indentations 295 formed therein.

The quiet-running multi-ply gear assembly 216 is assembled as shown in FIGS. 6 and 7. The bosses 225 and the indentations 295 are aligned, and the stiff center member 220 is fitted to the flange 293 with the planetary array of inwardly-directed semi-cylindrical projections of the bosses 225 received in the plurality of indentations 295. The apertures 247 and bosses 225 are registered and the compliant outer member 240 is received on one side of the stiff center member 220. The apertures 267 and bosses 225 are registered and the compliant outer member 260 is received on the opposite side of the stiff center member 220. Threaded fasteners 298 secure the compliant outer member 260 to the compliant outer member 240, with the stiff center member 220 and the flange 293 of the hub 290 disposed therebetween.

When the members 220, 240, 260 of the multi-layer gear assembly 216 are joined on the hub 290, their outer peripheral surfaces are aligned so as to register pairs of teeth 244, 264 on the compliant outer members 240 and 260 with each other and with a central tooth 224 on the stiff central member 220.

Preferably, the outer members 240 and 260 are formed of a compliant or semi-compliant material such as a reinforced nylon material. For example, the compliant or semi-compliant material may be a 40% glass-filled polyamide material such as Zytel® (or possibly another material). The central member 220 and the hub 290 may be formed of structural steel. Although the gear assembly is secured by bolting the outer members 240 and 260 together, the members of the gear assembly 216 can be fixed together in other ways such as by keying them, or by use of splines, or by other attachment techniques. When compared with the gear assembly shown in FIGS. 2 and 3, this construction reduces the cost of manufacturing a multi-layer quiet gear for two reasons. Only the stiff central member needs cutting. The compliant outer members can be cost effectively injection molded. In some aspects, the teeth of the center member are cut in the outer peripheral surface of the center member and the teeth of the outer members are molded with the outer peripheries of the outer members.

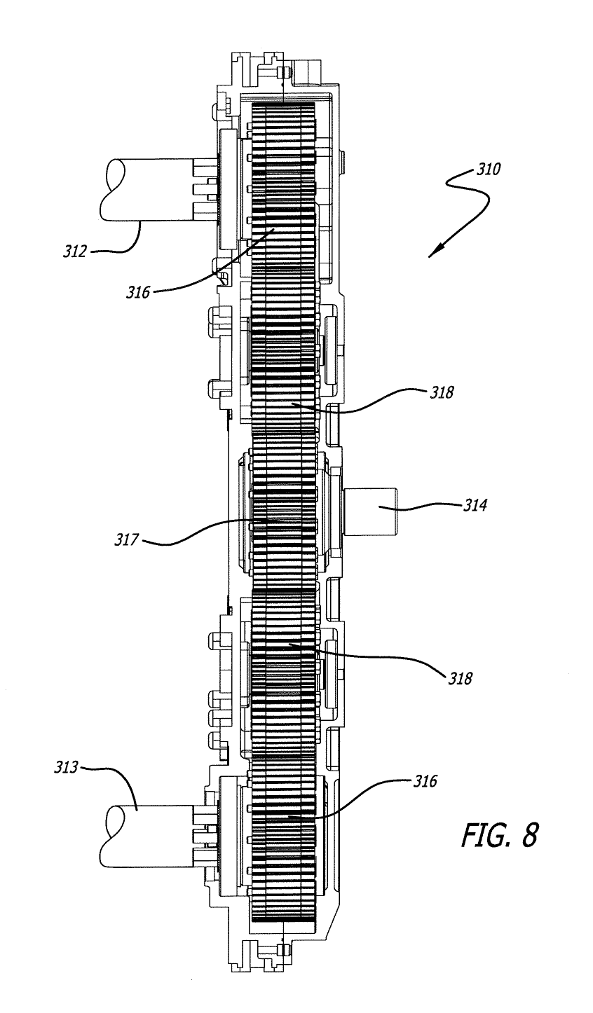

FIG. 8 shows a gear train 310 for an opposed-piston engine equipped with two crankshafts 312 and 313. The gear train 310 includes a plurality of gear assemblies (which may also be called “gears”), two of which (indicated by reference numeral 316) are fixed to respective ends of the crankshafts 312 and 313 for rotation thereby, and one of which (indicated by reference numeral 317) is fixed to the end of a power take-off shaft 319. In this configuration, two idler gear assemblies 318 are provided; as a result, the crankshafts 312 and 313 are co-rotating, that is to say, they rotate in the same direction. However, this is not meant to so limit the scope of this disclosure. In fact, the gear assembly construction disclosed in this specification can be incorporated into gear trains with fewer, or more, idlers, and with counter-rotating crankshafts. Presuming that the gear assemblies 316, 317, and 318 are constructed according to the multilayer construction illustrated in FIGS. 6 and 7, a method of operating the opposed-piston gear train 310 includes coupling rotating crankshaft motion from the crankshafts 312 and 313 into the gear train via gear assemblies 316 and coupling rotating motion out of the gear train via the gear assembly 317 to a power train via the power take-off shaft 314. As the crankshaft 312 rotates, a torque load is received on the members 240, 220, 260 of the gear assembly 316 that is mounted to the crankshaft. The compliant outer members 240 and 260 initially deform in response to the torque load, which is increasingly borne by the stiff center member 220.

It will be clear to a person of ordinary skill in the art that the above-described embodiments may be altered or that insubstantial changes may be made without departing from the scope of the underlying principles. Accordingly, the scope of patent protection afforded hereby is determined by the scope of the following claims and their equitable equivalents.

1. A gear assembly, comprising:
a center member of stiff material and including an outer peripheral surface with a plurality of teeth formed thereon;
a pair of outer members, each outer member including an outer peripheral surface with a plurality of teeth formed thereon, at least one of the outer members being made of a compliant material; and,
a hub;
in which the outer members are secured together on the hub with the center member disposed therebetween.

2. The gear assembly of claim 1, wherein the teeth of the center member and the teeth of the outer members are disposed in respective straight-cut patterns.

3. The gear assembly of claim 2, wherein the teeth of the center member are cut in the outer peripheral surface of the center member and the teeth of the outer members are molded with the outer peripheries of the outer members.

4. The gear assembly of claim 2, wherein first elements on the center member are interdigitated with second elements on the hub.

5. The gear assembly of claim 3, in which the plurality of teeth of the center member define one of a spur gear and a straight-cut gear.

6. The gear assembly of claim 1, in which the teeth of the center member are disposed in a straight-cut pattern while the teeth of the outer members are disposed in respective directed axial thrust patterns.

7. The gear assembly of claim 1, wherein first elements on the center member are interdigitated with second elements on the hub.

8. The gear assembly of claim 1, in which the plurality of teeth of the center member define one of a spur gear and a straight-cut gear.

9. The gear assembly of claim 1, wherein the teeth of the center member are disposed in one of a straight-cut pattern and a helical pattern and the teeth of each of the outer members are disposed in in one of a straight-cut pattern and a helical pattern.

10. The gear assembly of claim 1, wherein both of the outer members are made of a compliant material.

11. An opposed-piston engine, comprising an engine housing and a gear train mounted on the engine housing, in which the gear train includes a plurality of gears for coupling a pair of crankshafts to an output drive, wherein, each of the gears includes:
a center member of stiff material and including an outer peripheral surface with a plurality of teeth formed thereon;
a pair of outer members of compliant material, each outer member including an outer peripheral surface with a plurality of teeth formed thereon; and,
a hub;
in which the outer members are secured together on the hub with the center member disposed therebetween.

12. The opposed-piston engine of claim 11, wherein the teeth of the center member and the teeth of the outer members are disposed in respective straight-cut patterns.

13. The opposed-piston engine of claim 12, wherein the teeth of the center member are cut in the outer peripheral surface of the center member and the teeth of the outer members are molded with the outer peripheries of the outer members.

14. The opposed-piston engine of claim 12, wherein first elements on the center member are interdigitated with second elements on the hub.

15. The opposed-piston engine of claim 13, in which the plurality of teeth of the center member define one of a spur gear and a straight-cut gear.

16. The opposed-piston engine of claim 11, in which the teeth of the center member are disposed in a straight-cut pattern while the teeth of the outer members are disposed in respective directed axial thrust patterns.

17. The opposed-piston engine of claim 11, wherein first elements on the center member are interdigitated with second elements on the hub.

18. The opposed-piston engine of claim 11, in which the plurality of teeth of the center member define one of a spur gear and a straight-cut gear.
